(19) United States
(12) Patent Application Publication
(10) Pub. No.: US 2014/0141391 A1
(43) Pub. Date: May 22, 2014

(54) METHOD FOR REDUCTION OF ENERGY INTAKE

(71) Applicants: David Jason Mela, Vlaardingen (NL); Henricus Petrus F. Peters, Vlaardingen (NL); Simeon Dobrev Stoyanov, Vlaardingen (NL)

(72) Inventors: David Jason Mela, Vlaardingen (NL); Henricus Petrus F. Peters, Vlaardingen (NL); Simeon Dobrev Stoyanov, Vlaardingen (NL)

(21) Appl. No.: 14/130,342

(22) PCT Filed: Jun. 19, 2012
(86) PCT No.: PCT/EP2012/061646

§ 371 Date: Dec. 31, 2013

(30) Foreign Application Priority Data
Jul. 4, 2011 (EP) EP11172459

(51) Int. Cl. A23L 1/29; G09B 19/00

(52) U.S. Cl. CPC A23L 1/293; G09B 19/0092
USPC 434/127; 426/564; 426/2

(57) ABSTRACT

A method of facilitating compliance by individuals to low calorie diets, by ingestion of a pourable or spoonable aerated composition around a meal.

### FIELD OF THE INVENTION

The present invention relates to the field of diets reduced in calorie content, and a method in which such calorie reduced diets can be prescribed or adhered to, e.g. in order to control energy intake. Said diet and method include the ingestion of or prescription of an aerated food composition.

### BACKGROUND OF THE INVENTION

There is a large group of (human) individuals that desire to control weight (e.g. loose weight, or also to stay on the weight they have at a certain moment, i.e. to avoid weight increase), for medical reasons and/or for cosmetic reasons (e.g. because they believe it enhances their appearance). For most people, this will result in a desire to limit their intake in calories, e.g. through dieting following a diet plan or scheme, or self-imposed eating restrictions. However, this may give to such individuals, at certain moments on a day, feelings of hunger, and/or a desire to consume a meal or a snack, and/or a lack of fullness and/or satiety some time after consumption of a meal. This can feel highly unpleasant for the individual concerned, and optionally may lead to individuals to consume more calories than they wish, e.g. by increasing the size or caloric content of their meals and/or by consuming snack foods in between meals or snack foods with more calories.

WO 08/46729 discloses the use of edible foams as a way to induce satiety. It discloses a study in which is consumed either a single dose of 1000 ml foam product, or twice a dose of 500 ml foam product.

B J Rolls et al (Am J Clin Nutr 2000; 72, 361-368) disclose that a single dose of an aerated milkshake as a preload to a lunch can affect satiety.

### SUMMARY OF THE INVENTION

Thus, it is an object of the present invention to provide a method for reducing feelings of hunger and/or a desire to consume a meal or a snack and/or a lack of fullness and/or satiety some time after consumption of a meal, and/or a method for reducing prospective food consumption, especially for people who ingest or desire to ingest a reduced amount of energy. “Reduced” can be reduced in the energy intake required for maintenance of body weight and/or a certain amount of kilocalories less than what would be required for maintenance of body weight by said individual. Typically, a diet reduced in energy content contains, in kilocalories, less than 2500 kcal, preferably less than 2000 kcal for adult men and less than 2000 kcal, preferably less than 1500 kcal for adult women. It may also be desired to provide a method for reducing energy or food intake, and/or for reducing body weight and/or for maintaining a desired body weight. It may also be desired to provide a way to “make dieting do-able”, which herein refers to dealing with part of the feelings the individual may experience when consuming a reduced amount of calories on a day, and which feelings, if not dealt with otherwise, may lead to an undesired increase in calorie intake.

It is also an object of the present invention to provide a method for facilitating adherence to a diet plan or scheme, or a calorie or weight reduction scheme or plan and/or to improve likely adherence to a diet plan or scheme, or a calorie or weight reduction scheme or plan. It is also an object to provide a method for maintenance of a desired calorie intake and/or body weight of an individual after having followed a diet plan or diet scheme or weight reduction scheme.

It has now been found that the above objectives may be achieved, at least in part by a method for reduction of food or energy intake in an individual, which method comprises:
ingesting by the individual a diet reduced in calories,
said diet comprising at least two eating occasions on a day, wherein such eating occasion is the ingestion of an amount of food of at least 150 g and providing at least 200 kilo calories,
which method further comprises ingestion by said individual on at least two different of such eating occasions on a day or within 60 minutes prior to or after such eating occasion a portion of a pourable or spoonable aerated composition,
wherein each portion of aerated composition is an edible composition having a volume of 50 to 400 ml, an overrun of more than 100%, and a caloric density of less than 3 kcal/ml.

In another embodiment the invention relates to a method for reduction of food or energy intake in an individual, which method comprises
prescribing to the individual a diet reduced in calories,
said diet comprising at least two eating occasions on a day, wherein such eating occasion is the ingestion of an amount of food of at least 150 g and providing at least 200 kilo calories,
which method further comprises prescribing to such individual on at least two different of such eating occasions on a day or within 60 minutes prior to or after such eating occasion the ingestion of a portion of a pourable or spoonable aerated composition,
wherein each portion of aerated composition is an edible composition having a volume of 50 to 400 ml, an overrun of more than 100%, and a caloric density of less than 3 kcal/ml.

### DETAILED DESCRIPTION OF THE INVENTION

“Diet reduced in calories” is herein a diet reduced in calorie intake compared to the habitual daily intake of the individual concerned. More preferably, the “diet reduced in calories” is preferably such that the caloric content of the diet is at least 10% below the energy intake required for maintenance of body weight. Such varies for women and men, and it may be preferred that the diet reduced in calories is at least 500 kcal below what is required for maintenance of body weight. Even more preferably, the “diet reduced in calories” is preferably such that it contains less than 2500 kcal, preferably less than 2000 kcal, for adult men being the individual in the method, and less than 2000 kcal, preferably less than 1500 kcal, for adult women being the individual in the method.

“Reduction of food or energy intake” herein means a reduction in the food or energy intake as desired by an individual having an unrestrained eating behaviour, when compared to individuals who do not employ the method according to this invention.

“Eating occasion” herein means the ingestion of an amount of food of at least 150 g and providing at least 200 kilo calories, preferably of an amount of food of at least 200 g and providing at least 250 kilo calories.

“Adjunct to a meal” herein means food consumed as part of or with a (main) meal, or intended or preferred to be consumed as part of or with a (main) meal. A non-limiting example of an adjunct to a meal is a dessert, or a starter (aka entrée in french language).

“Snack” herein means food consumed in a limited amount as expressed by a portion having a weight of from about 30 to about 250 g, more specifically from about 50 to about 150 g, and which is not intended and/or marketed as a main meal, meal, or meal replacer, but intended and/or marketed as something that can be consumed on its own and/or intended and/or marketed for consumption at moments in between (main) meals, e.g. between breakfast and lunch, between lunch and dinner, between dinner and going to bed. “Snacking” herein means the consumption of a snack, not as a meal, main meal or meal replacer.

“Meal” herein means one or more of breakfast, lunch, or dinner. “Main meal” is herein the meal that provides the largest amount of calories on a given day.

“Edible” and “foodstuff” herein encompasses something suitable for human consumption, be it by eating and/or drinking, thus including solid, spoonable and drinkable foodstuffs.

“Fat” herein encompasses edible lipophilic matter, including triglycerides of fatty acids, both solid and liquid.

“Aerated” herein means a composition which comprises a plurality of gas bubbles. The gas can be any compound gaseous at ambient pressure and temperature. Examples include: N₂, N₂O, CO₂, He, O₂, air, and mixtures thereof, and thus is not limited to any particular gas composition. “Aerated composition” and “foam” are herein used interchangeably, and are to be understood as to mean the same.

Although aerated products have been used in trials before, and their effects on satiety has been reported, such was on using comparatively large volumes. It was now surprisingly found that aerated compositions have effects on hunger and appetite-related feelings of an individual when taken in fairly small portions (which is a distinct advantage from a consumer point of view, as large portions of more than 400 ml of an aerated composition are for most individuals difficult to consume entirely). It was also surprisingly found that ingestion of such aerated composition just after an eating occasion like a meal (breakfast, lunch or dinner) provided the strongest effect on feelings of hunger, appetite for a meal, prospective food consumption, feelings of fullness, feelings of satiety, and appetite for a snack: one would intuitively expect that the effect would be biggest when the aerated composition is taken not with a meal (as such by the virtue of its composition and calorie content) already gives feelings of satiety etcetera. More specifically, it was surprising that aerated compositions can decrease, in an individual, feelings of hunger, for a meal or a snack in between meals, and/or increase feelings of satiety, and/or decrease the desire to prospective food consumption, and/or decrease feelings of craving for food or a snack, and/or increase the feeling of fullness, and/or reduce appetite for a meal or a snack in between meals with these relatively small portions and when ingested at the times indicated. It was also surprisingly found that the effects could be seen in persons who are on a calorie restricted diet. Although the trial from which the evidence results was only for one day per treatment, there is no reason to believe that the effects would not be seen if such treatment (calorie restricted diet+consumption of an aerated composition multiple times a day) would be repeated several days. This, it is believed, can help individuals to deal with the feelings of hunger and/or appetite for a snack and/or appetite for a meal that they may perceive when on a calorie restricted diet, even for a period of several days. This, it is believed, can help making a (calorie-restricted) diet do-able, a wish so many individuals have.

Although in the trial on which the present invention is based the aerated composition was consumed directly after breakfast, lunch and dinner, it is believed, also based on the effects seen when the aerated composition was consumed with a snack or between a meal and a snack that the effects can also be seen when the aerated composition is consumed in a time interval around a meal or eating occasion, e.g. from 60 minutes prior to 60 minutes after such eating occasion. However, in the methods and uses herein, it may be preferred that the individual ingests on at least two different of such eating occasions on a day or within 30 minutes prior to or after such eating occasion a portion of an aerated composition according to the invention. Most preferred as eating occasion are in this respect meals selected from breakfast, lunch or dinner. The ingestion of the portion of the aerated composition are preferably part of an eating occasion or are an adjunct to an eating occasion (e.g. for ease of use). Examples of the latter are e.g. pre-meal drinks or after meal desserts (e.g. after lunch and/or dinner). Hence, the invention also relates to a method as set out above, wherein the method comprises ingestion of said portion of said aerated composition as part of or an adjunct to an eating occasion.

The edible aerated composition in the method and uses of the present invention is a pourable or spoonable aerated composition. According to one embodiment, the product is non-pourable. Such a non-pourable product typically exhibits spoonable rheology defined as follows: yield value of >50 Pa, when extrapolating from shear rates between 100 and 300 s⁻¹, a Bingham viscosity<500 mPa·s between shear rates of between 100 and 300 s⁻¹, a failure at stress at a strain of <0.5 Radians. The yield stress is determined at a temperature of 20° C. using a Haake VT550 viscometer. According to another embodiment, the edible foam product is pourable. A pourable product offers the advantage that it can be drunk. If the product is drunk rather eaten, the chance of undesirable density increase as a result of mastication is minimised—for example bread is high overrun product, but practically all air is lost during mastication.

The edible aerated composition in the methods and uses of the present invention is not a mousse. A mousse has a continuous phase that is a gelled phase, and this is to be distinguished from the currently used pourable and spoonable aerated compositions, in which the continuous phase of the aerated composition is not a gelled phase.

The edible composition in the method and uses of the present invention preferably comprises by weight 50-99.5% water, a foaming agent and a stabiliser.

In the composition of the method and use according to the present invention, the foaming agent preferably comprises, for a good aerated composition, one or more of:
a food grade water-soluble emulsifier having an HLB value of at least 8, preferably at least 9, more preferably at least 12,
a food grade protein;
food grade amphiphatic particles having a contact angle at air/water interface between 70 and 120 degrees, and preferably having a volume weighted mean diameter of 0.02 to 10 micron (μm).

Examples of preferred food grade water-soluble emulsifier having an HLB value of at least 8, preferably at least 9, more preferably at least 12 herein are: sodium docecyl sulfate (SDS), SSL, Tween 20, Tween 40, Tween 60 (POE 20 sorbitan monostearate), Molec MT (enzymatically hydrolysed lecithin) and L1695 (lauric ester of sucrose ex Mitsubishi-Kasei Food Corp.), and DATEM (diacetyl tartaric acid ester of monoglyceride).

Preferred food grade proteins comprise dairy proteins such as whey protein and/or casein protein and sources thereof, as well as vegetable proteins like soy protein, meat- and fish derived protein, and egg protein like albumin. When used as sole foaming agent, such food grade proteins are preferably used in an amount of from 1 to 7% by weight. Preferred food grade amphiphatic particles herein comprise one or more of cocoa particles.

As to the stabiliser, e.g. to give the product sufficient physical stability, e.g. to allow some time between preparation of the aerated composition, it is preferred that the stabilizer comprises a dietary fibre or a sucrose ester. Preferred amounts in this context are: from 0.1 to 5% by weight. Too little may not provide the desired stability, too much may make aeration difficult.

Suitable dietary fibres in this context are one or more of the group consisting of: carrageenan, xanthan, cellulose, gellan, locust bean gum, with xanthan being the most preferred stabiliser (as it provides stabilising without too much viscosity increase).

Fat may be present in the compositions in the methods and uses according to this invention, but such is preferably kept at a low level, so as not to induce too much calories to the composition. Also, fat may act detrimental on the stability of the aerated compositions. Hence, in the compositions in the methods and uses herein, the edible aerated composition comprises fat in an amount of less than 2% by weight, preferably less than 1.8% by weight, more preferably between 0 and 1.8% by weight, even more preferably between 0 and 1.5% by weight, even more preferably form 0.01 to 1.5% by weight.

Next to the foaming agent, stabiliser, water and optionally fat, other components that may be present include carbohydrates, (non-caloric) sweeteners, flavouring components.

Commonly known aerated compositions that are consumed as a snack product are ice cream portions. However, e.g. for ease of supply chain and/or distribution channel, the aerated composition as in use in the present method and uses is preferably a non-frozen composition (preferably such means: products which are sold, marketed and/or consumed at product temperatures above 0° C.).

As said, the compositions in the method and uses of the present invention are such that they have an overrun of at least 100%. According to a preferred embodiment, the edible aerated product in the method and uses of the present invention has an overrun of at least 120%, more preferably of at least 150%, and even more preferably between 150% and 800%. The overrun of an aerated product is calculated using the following equation:

Overrun=100%×(V_{foam product}−Vₘᵢₓ)/Vₘᵢₓ

V_{foam product}=Volume of a sample of the edible aerated product
Vₘᵢₓ=Volume of the same sample after the dispersed gas phase has been removed.

The edible aerated composition in the method and uses of the present invention typically contains at least 50 vol. % of a dispersed gas phase (which equates to an overrun of 100%). Preferably, the product contains at least. 60 vol. % of a dispersed gas phase. The vol. % of gas phase (φ) contained in the present product may suitably be determined by measuring the density of pre-aerated solution, ρ₀, and the density of the aerated product, ρ_{f}, and applying the following equation: φ=100(1−ρ_{f}/ρ₀) and is related to the overrun as follows: φ=100 Overrun/(100+Overrun). The gas phase in the present product can comprise air or any other gas that is considered safe for food applications.

It is believed that the benefits of the present invention may be obtained with any type of edible aerated composition as specified for the method and uses of this invention, but preferably it exhibits sufficient in-mouth and gastric stability. In this connection it is preferred that said aerated composition have a foam stability such that said aerated composition has a bench-life stability of at least 1 hour, wherein bench-life is determined by:
preparing a sample of the aerated composition
transferring a certain amount into a measuring glass cylinder which has been previously tared on a balance
measuring the total foam volume measure the total mass of the foam
covering the top of the cylinder with parafilm to prevent evaporation.
measure the liquid volume at the bottom of the cylinder
placing the measuring glass cylinder on a lab bench at ambient temperature.
recording the total foam volume and drained liquid from the foam at 5 minute intervals for a period of at least 60 minutes.
calculating overrun for each time point.

If within 60 minutes one or more of foam collapse, severe creaming, and severe disproportionation has occurred resulting in a reduction of overrun of more than 50%, the aerated composition does not have a sufficient bench-life stability.

More preferably, the aerated composition as in use in the methods and uses of the present invention has a physical (foam) stability such that the foam has a half life in the stomach of at least 20 minutes, preferably at least 30 minutes, more preferably of at least 45 minutes. “Foam half life in the stomach” herein is the gastric retention time where 50% of the foam volume ingested remains present as an aerated composition in the stomach. The presence of an aerated composition in the stomach, and thus the half life, can be determined by visualisation techniques as known in the medical profession. Of these, MRI imaging or CT scanning are preferred techniques, as they directly show the presence of foam, air and liquid. Ultrasound imaging can also be used for this, but due to differences in image quality and the interpretation of it a large enough set of test persons would be needed, as a person skilled in the art of ultrasound imaging would know. Also, with ultrasound imaging an aerated composition in the stomach as such cannot be visualised using ultrasound imaging, but the presence of foam can be derived from the reappearance of antral motility and ultrasound signal after the foam has left the stomach. Also, these imaging techniques can also be used to determine whether an aerated composition has a sufficient stability to pass the mouth and be present for some time as an aerated composition.

Even more preferably, the aerated compositions as in use in the method and uses of the present invention have a very high in-mouth stability and gastric stability. Such high gastric stability of the aerated product can be apparent from the time (t_{1/2}) needed to achieve a reduction in overrun of 50% under gastric conditions. The aerated product of the present invention exhibits a t_{1/2} of more than 30 minutes. The high in-mouth stability of the present aerated product is evidenced by a reduction in overrun of less than 35% when a sample of the product is subjected to a stability test in which conditions of shear are applied that are similar to those observed in the mouth. The aforementioned parameter t_{1/2} is determined in a gastric stability test involving combining 400 ml of the aerated product with 15 ml of an artificial gastric juice comprising 60 mg of 1:1 (wt) pepsin/lipase mix (pepsin from hog stomach, activity 724 U/mg, Fluka BioChemika, cat. no. 77160; lipase from Rhizopus oryzae, activity 53 U/mg, Fluka BioChemika, cat. no. 80612) in 1M HCl containing 150 mM NaCl and 5 mM KCl. The aerated product is placed in a glass cylinder (length 200 mm, diameter 60 mm) and the artificial gastric juice is poured on top of the foam product. The cylinders are placed in a thermostated shaking water bath (37° C.), operating at a shaking rate of 1.2 s⁻¹, while the stability of the foam product is monitored.

The in-mouth stability of an aerated product as referred to in the previous paragraph can determined by introducing a predetermined volume of an edible aerated product in a glass funnel (diameter 100 mm, neck length 100 mm, neck diameter 10 mm), which is connected to a silicone tube (length 400 mm, diameter 12×8 mm). The middle part of the silicone tube is inserted into a peristaltic pump Verderflex 2010 (Verder Ltd, Leeds, UK) operating at 60 rpm.

After the processing in the peristaltic pump the sample is collected in a glass measuring cylinder and the product volume and product weight are measured immediately. In the shear test described above the aerated products in the methods and uses of the present invention typically show a reduction in overrun of less than 30%, preferably of less than 25%, most preferably of less than 22%. In contrast, known edible aerated products, such as chocolate mousse and whipped cream, show decreases in overrun that are well in excess of these percentages.

According to another preferred embodiment, the product obtained from the in-mouth stability test described above still exhibits an overrun of at least 100%, more preferably of at least 120%, and even more preferably at least 150%. Edible foam products that are capable of retaining a high overrun when subjected to conditions of shear that are similar to those observed during mastication and that additionally exhibit high stability under gastric conditions are extremely useful for the purposes of this invention. According to a particularly preferred embodiment, the aforementioned criteria are also met by the aerated products in the present method and invention if the shear stability test is conducted at a temperature of 37° C., thus reflecting the prolonged in-mouth stability of the product under conditions of shear that are similar to those exerted during mastication.

The benefits of the aerated product in the present invention are particularly pronounced in case the in-mouth and gastric stability is very high. Accordingly, in a particularly preferred embodiment t_{1/2} exceeds 45 minutes, even more preferably it exceeds 60 minutes, even more preferably it exceeds 90 minutes and most preferably t_{1/2} exceeds 120 minutes.

The edible aerated compositions for use in the methods and uses as specified herein can be prepared by any suitable means. The aerated compositions may be manufactured, packed and marketed in an aerated form, but it is also possible to prepare a non-aerated product which is packed and marketed, which is then aerated some time or immediately before consumption, either by the individual or at a point of sale. A convenient way (and one which can easily give aerated compositions of high stability) to offer such to users is when the composition for use in the method and uses of this invention is packed as a non-aerated (e.g. liquid) composition in a pressurised container in a liquid form. By this, the pressurised container can hold the edible liquid (non-aerated) composition and a propellant, which liquid composition can be released from the container by activating a valve (on the container) to produce an edible aerated product. Hence, more preferably, the invention further relates to the use in the method and uses of the present invention of a pressurised container further comprising a propellant, and wherein the pressurised container is equipped with a valve, wherein the liquid can be released from the pressurised container by activating said valve to produce the aerated composition for the method and uses according to this invention. Typically, the edible aerated product thus obtained has a density that is much lower (e.g. 40% lower) than that of the liquid composition in the container. According to a preferred embodiment, the edible aerated product produced upon activation of the valve has the same composition as the edible liquid composition (gas phase not being included).

Suitable propellants in this include compressed gases, especially liquefied gasses. Preferably, the propellant employed is selected from N₂O, N₂, CO₂, air and combinations thereof. Most preferably, the propellant employed is selected from N₂O, N₂, CO₂ and combinations thereof. Typically, the propellant contained in the pressurised container has a pressure of at least 2 bar, more preferably at least 3 bar. Usually, said pressure does not exceed 12 bar.

Whether the aerated composition in the methods and uses as set out herein is packaged in a pressurised container or not, it is preferred in the present invention that the aerated composition is prepared by the user from a composition which is packaged as a liquid. This liquid is then to be turned into the aerated composition before being consumed.

The gas bubbles contained within the edible aerated composition in the method and uses according to this invention can vary widely in size. Typically, the air bubbles in the product have a volume weighted mean diameter in the range of 5-500 μm, preferably of 10-200 μm. The volume weighted mean diameter of the gas bubbles is suitably determined by means of optical microscopy.

The stability of the edible aerated product, especially if it is produced in situ from a pressurised aerosol system, is affected by the composition of the gas that is retained within the aerated product. In order to generate a very stable aerated product, it is advantageous to include a gas that has limited water-solubility. Air, for instance, is not particularly suitable as e.g. oxygen has a relatively high solubility in water. According to a particularly preferred embodiment, the edible aerated product in the present invention contains a gas that is less soluble in water than air (at a temperature of 37° C. According to another preferred embodiment, relative to air, the gas contained in foam product contains elevated levels of one or more of the following gasses: N₂, N₂O, CO₂, He, O₂. Here the term “elevated” means that the concentration of at least one of said gasses is at least 10% higher than in air.

The gas bubbles contained within the edible aerated composition in the method and uses according to this invention can vary widely in size. Typically, the air bubbles in the product have a volume weighted mean diameter in the range of 5-500 μm, preferably of 10-200 μm. The volume weighted mean diameter of the gas bubbles is suitably determined by means of optical microscopy.

As said, in the method and uses of the present invention the individual has at least two defined eating occasions on a day, and at at least two different eating occasions is to ingest the edible pourable or spoonable aerated composition as specified. Preferably, in the method and uses of the present invention, the individual ingests at least two portions of the aerated composition, and the total amount of all portions of aerated composition ingested per day is from 300 to 1400 ml, preferably from 400 to 800 ml.

It is known that edible aerated compositions that contain a substantial amount of calories suppress, after ingestion, the desire to eat a meal or snack, and more so than a similar sort of food product containing fewer calories. Hence, one can say that in order to suppress feelings of hunger after ingestion for substantial periods of time, a composition for the given purpose should contain a substantial amount of calories. However, it was found that in the method now claimed, already with aerated compositions that are low in caloric content, the desired objectives can be met. As the aim is to apply the aerated compositions in the current method in calorie-restricted diets, it is preferred that the composition for use in the current method is has a low caloric density. Caloric density of the aerated composition used in the current methods herein is digestible (for humans) calories per volume (or weight, depending on what is specified) of aerated compositions. Hence, in the current methods, it is preferred that in the methods and uses of the present invention, the aerated composition has a caloric density of less than 2 kcal/ml, preferably less than 1 kcal/ml, more preferably less than 0.5 kcal/ml of aerated composition (ready for consumption).

It has been mentioned that the method and uses are suitable for individuals ingesting a diet reduced in calories. In this context, it is preferred that the diet reduced in calories has said reduction (in calories) compared to the habitual daily intake of said individual. Even more preferably, the diet reduced in calories herein is at least 10% below the energy intake required for maintenance of body weight. Alternatively put: the diet reduced in calories is at least 500 kcal below what is required for maintenance of body weight. Even more preferably, and now specifically for men and women, as they have different average energy requirements, the diet reduced in calories contains less than 2500 kcal, preferably less than 2000 kcal, for adult men and less than 2000 kcal, preferably less than 1500 kcal, for adult women.

It was found that the present invention is very suitable for individuals who follow a diet plan or a weight reduction or weight maintenance scheme. Hence, the invention further relates to the methods and uses as set out herein, wherein the method is used for individuals for compliance to a diet plan and/or for weight reduction and/or for weight maintenance after having followed a weight reduction diet and/or for a controlled energy intake of an individual after said individual has followed a weight reduction diet.

### Example

### Study Design

This study had an unblinded, randomized assignment, parallel design, with control and three treatments balanced across test days. On the test day, volunteers followed a (calorie-restricted) diet plan (1200 kcal per day for women, 1500 kcal per day for men, see below), consisting of fixed snacks and meals: a breakfast at 8 AM, a mid-morning snack at 10 AM, a lunch at 12.30 PM, a mid-afternoon snack at 2 PM, a dinner at 5 PM and an evening snack at 6.30 PM. The volunteers were allowed to go home at 9 PM.

The control treatment consisted of the diet plan with no addition of foam products.

The three treatments consisted of the diet plan plus three times a day a portion of a foamed liquid at different timings: 1) either immediately after the main meals, 2) immediately after the snacks or 3) in between snacks and main meal. The foam products have a uniform composition, volume and overrun throughout the study, and each portion of such contains approximately 22 kcal.

The controls received the entire 1200/1500 kcal of the diet plan. By applying small adjustments to the main meals subjects in the treatment groups received 66 kcal less from this diet plan throughout the day to compensate for the 3 times 22 kcal in the foam products. As a consequence all groups consumed the same amount of energy during the test day.

Study parameters were eating motivation and overall satisfaction with the diet plan. For a schematic overview of the study see Table 1.

TABLE 1
Time (hours):

| | 08.00 | 10.00 | 11.00 | 12.30 | 14.00 | 15.30 | 17.00 | 18.30 | 19.30 | 21.00 |
|---|---|---|---|---|---|---|---|---|---|---|
| 1. | breakfast | snack | — | lunch | snack | — | dinner | snack | — | end |
| 2. | breakfast + F | snack | — | lunch + F | snack | — | dinner + F | snack | — | end |
| 3. | breakfast | snack + F | — | lunch | snack + F | — | dinner | snack + F | — | end |
| 4. | breakfast | snack | F | lunch | snack | F | dinner | snack | F | end |

### Subjects

Healthy normal weight and overweight male and female participants (age 18-60 yr, BMI 22.5-35 kg/m²) were recruited from local area of the research centre. Only normal and low-restraint eaters were included, based on the Revised Restraint Scale (Polivy et al., 1978; Federoff et al., 2003). Any subject with a tendency toward a diagnosable eating disorder (anorexia nervosa or bulimia) was also excluded based on the SCOFF questionnaire (Morgan et al., 1999). Potential volunteers were trained on completion of visual analogue scales (VAS) for subjective ratings of ingestive behavior, and were familiarized with the test product and the study design.

From the eligible participants identified, 144 were admitted onto the study and randomized into 4 groups of 36 subjects per treatment, with groups matched for gender mix, age and body weight. Three subjects withdrew from the study (one subject revealed being a smoker during the study day and two subjects did not show up). In total 141 subjects completed the study.

Following the blind review of the study data, seven subjects were withdrawn from the analysis for various reasons (one reported sickness before the study, three used medication before the study that could have affected the study outcome, two consumed evening dinner too late and one subject showed no change in appetite throughout the day). Characteristics of the remaining 134 subjects that fully complied with the study protocol (79 females, 55 males) were: age: 38.2 (range 18-60) y; BMI: 25.8 (range 21.7-34.8) kg/m².

### Study Meals and Test Foods

The study meals are given in Table 2.

TABLE 2
Study meals used for the diet plan*.

| | | Women | | | | Men | | | |
|---|---|---|---|---|---|---|---|---|---|
| | | Diet control [1200 kcal] | | Diet + foam [1134 kcal] | | Diet control [1500 kcal] | | Diet + foam [1434 kcal] | |
| Food | kcal/100 g | Weight (g) | kcal | Weight [g] | kcal | Weight [g] | kcal | Weight [g] | kcal |
| BREAKFAST | | | | | | | | | |
| Cornflakes | 380 | 30 | 114 | 29 | 110.2 | 35 | 133 | 35 | 133 |
| Skimmed milk | 37 | 110 | 40.7 | 110 | 40.7 | 140 | 51.8 | 135 | 49.95 |
| Pure Orange Juice Smooth | 47 | 135 | 63.45 | 132 | 62.04 | 150 | 70.5 | 146 | 68.62 |
| Apple | 50 | 104 | 52 | 100 | 50 | 140 | 70 | 135 | 67.5 |
| SNACK | | | | | | | | | |
| Banana | 100 | 99.5 | 99.5 | 98 | 98 | 143 | 143 | 140 | 140 |
| LUNCH | | | | | | | | | |
| Wholemeal bread | 220 | 88 | 193.6 | 88 | 193.6 | 88 | 193.6 | 88 | 193.6 |
| Flora spread | 530 | 14 | 74.2 | 11 | 58.3 | 19 | 100.7 | 17 | 90.1 |
| Cooked turkey slice | 110 | 22 | 24.2 | 20 | 22 | 34 | 37.4 | 30 | 33 |
| Tesco four leaf salad | 15 | 20 | 3 | 20 | 3 | 25 | 3.75 | 25 | 3.75 |
| SNACK | | | | | | | | | |
| Low fat natural yoghurt | 70 | 100 | 70 | 96 | 67.2 | 150 | 105 | 145 | 101.5 |
| Dried apricots | 170 | 13 | 30.6 | 16 | 27.2 | 25 | 42.5 | 24 | 40.8 |
| DINNER | | | | | | | | | |
| Penne pasta (dry weight) | 355 | 75 | 266.25 | 69 | 244.95 | 90 | 319.5 | 82 | 291.1 |
| Tesco original pasta sauce | 41 | 125 | 51.25 | 123 | 50.43 | 150 | 61.5 | 146 | 59.86 |
| Tesco four leaf salad | 15 | 50 | 7.5 | 50 | 7.5 | 55 | 8.25 | 50 | 7.5 |
| Hellmanns Vinaigrette | 49 | 15 | 7.35 | 15 | 7.35 | 18 | 8.82 | 17 | 8.33 |
| Light Salad Dressing | | | | | | | | | |
| SNACK | | | | | | | | | |
| Tesco Rich Plain Chocolate | 540 | 19 | 102.0 | 17 | 91.8 | 28 | 151.2 | 27 | 145.8 |
| Total energy [kcal] | | | 1200.2 | | 1134.27 | | 1500.52 | | 1434.41 |

*The control group received the entire 1200 or 1500 kcal. The other treatment groups received 66 kcal less throughout the day to compensate for the 3 times 22 kcal in the foam products

Participants were given the 200 ml foamed portion in a glass and instructed to eat all of the foam with a black plastic spoon within 10 minutes. Each foam portion was provided to subjects either immediately after the main meals, immediately after the snacks, between the main meals and snacks or not at all (control).

The foamed test products consisted of approximately 200 ml chocolate foams prepared by dispensing a liquid mixture from pressurised canisters. The dispensing was according to a standard procedure: all foam canisters were stored at least 30 minutes before dispension in a fridge at 5° C. Five consecutive 200 ml portions were dispensed from the same canister into the glasses. The foams from the third, fourth and fifth glass were used for the study. Participants were given the foam with a black plastic spoon and instructed to eat all of the foam within 10 minutes.

The liquid mixture in the pressurised canisters consisted of approximately 41 ml of chocolate high protein ready-to-drink shakes (22 kcal, approximately 39.2 gram), while the gas part consisted of approximately 159 ml N₂O. Measured overrun was approximately 430%. Nutrition facts and ingredients list of the non-aerated high protein chocolate shake base are shown in Table 3.

The liquid base of this foam consisted of the Slim•Fast High Protein Extra Creamy Chocolate RTD shake (US formulation), of which the regular chocolate flavor was exchanged for another type of flavor.

TABLE 3
Nutrient composition of High Protein Chocolate shake
(used as the liquid base for the foams) (amounts per
Can (325 ml, when not aerated)

| | |
|---|---|
| Calories | 190 |
| Total Fat | 5 g |
| Saturated Fat | 2 g |
| Total Carbohydrate | 24 g |
| Dietary Fiber | 5 g |
| Sugars | 13 g |
| Protein + | 15 g |
| Vitamin-Mineral complex | |

Ingredients: Fat Free Milk, Water, Calcium Caseinate, Milk Protein Concentrate, Maltodextrin, Cocoa (Processed with Alkali), Canola Oil, Gum Arabic, Cellulose Gel, Sugar, Mono and Diglycerides, Fructose, Potassium Phosphate, Soybean Lecithin, Cellulose Gum, Carrageenan, Artificial Flavor, Isolated Soy Protein, Sucralose and Acesulfame Potassium (Non Nutritive Sweeteners), Dextrose, Potassium Carrageenan, Citric Acid and Sodium Citrate.

Vitamins and Minerals: Magnesium Phosphate, Calcium Phosphate, Sodium Ascorbate, Vitamin E Acetate, Zinc Gluconate, Ferric Orthophosphate, Niacinamide, Calcium Pantothenate, Manganese Sulfate, Vitamin A Palmitate, Pyridoxine Hydrochloride, Riboflavin, Thiamin Mononitrate, Folic Acid, Chromium Chloride, Biotin, Sodium Molybdate, Potassium Iodide, Phylloquinone (Vitamin K1), Sodium Selenite, Cyanocobalamin (Vitamin B12) and Cholecalciferol (Vitamin D3).

### Subjective Feelings of Hunger/Satiety and Diet Satisfaction

Study parameters were eating motivation and overall satisfaction with the diet plan, all collected on electronic hand held devices (iPAQ).

Ratings of satiety feelings were scored using reproducible and valid scales (Stubbs et al., 2000; Flint et al. 2000) by means of a mark on 60-mm scales using EVAS (Electronic Visual Analogue Scale; Stratton et al. 1998) anchored at the low end with the most negative or lowest intensity feelings (e.g., not at all), and with opposing terms at the high end (e.g., very high). Volunteers were asked to indicate on a line which place on the scale best reflects their feelings at that moment. The scale items were “appetite for a meal”, “appetite for a snack”, “hunger”, “how much do you want to eat”, “satiety” and “fullness”.

Overall satisfaction with the diet plan with or without (control) the foamed compositions was also filled on EVAS using an end-of-day questionnaire with several scale items as defined in Table 4.

### Background Diet and Other Measurements

Participants were instructed to minimise changes in their physical activities and were not allowed to follow a diet one month prior to and during the test period. On the day before the test day subjects were instructed not to use alcohol or play sports. Volunteers were asked to refrain from consuming any food or drink other than non-caloric beverages from 10 PM arrival at the test facility.

Until the last questionnaire was completed on the iPAQ, volunteers were only allowed to eat and drink the items included in the diet plan. Consumption of non-caloric drinks (water, coffee/tea without milk/sugar; maximum 150 ml per occasion) was only allowed with the main meal or the diet plan snacks and directly after completing the questions on the iPAQ.

### Statistical Analyses

Based on a subject variance of 170 (for Area under the Curve), an alpha of 0.05 (corrected for Dunnett's difference testing) and a power of 0.8, a difference of 10 points AUC and taking into account drop-outs, 36 subjects per group were required.

Both Intention-to-treat and per-protocol (PP) analyses were performed. The subjects to be excluded from the PP analysis were defined during a blind review.

Data were analyzed using ANCOVA with baseline values (=questionnaires completed after arrival at the lab, 7.45 AM) as covariates and groups as factor. Differences were tested using Dunnett's difference test. Using this test each treatment was compared with the control. Feelings of hunger/satiety and liking were measured by means of a mark on electronic 64-mm line scales, and these appetite EVAS scores were transformed and expressed on a 100-mm basis.

The primary study parameter was the eating motivation response as reflected by area-under-the-curve (AUC) for the entire day and for morning, afternoon and evening separately. Secondary study parameters were overall satisfaction with the diet plan as reflected by the end-of-day questionnaire at 9 PM.

### Results

Compliance to the diet plan was generally very high. Only very few subjects ingested a bit less during the day, mostly because of very small left-overs. Eleven out of 79 women consumed between 1 and 19 kcal less (mean 8 kcal) than the prescribed 1200 kcal, while 1 woman consumed 97 kcal less. Seven out of 55 men consumed between 3 and 38 kcal less (mean 19 kcal) than the prescribed 1500 kcal. Study results with and without these subjects resulted in the same conclusions. All results are shown for persons compliant to the study protocol (i.e., per-protocol population, n=134, including those having eaten less than prescribed).

The consumption of approximately 200 ml foam induced clear effects on eating motivational ratings, particularly when consumed immediately after the main meals. An example of the effect of the foam products is shown for hunger (FIG. 1a), fullness (FIG. 1b) and appetite for a snack (FIG. 1c). The effects on the other 3 line scales are in line with these.

Based on these data, differences in AUC versus control were calculated for the entire day period. These are shown in FIG. 3 for all line scales.

The ingestion of foams reduced appetite ratings throughout the day. However, surprisingly, this reduction was particularly evident when the foams were consumed immediately after the main meals (Hunger AUC, for instance, was reduced by approximately 35%, P<0.01). Effects were also evident when the foam snacks were consumed immediately after the snack or when consumed in between snacks and the main meals, but for all 6 line scales effects were smaller as compared to reductions of scales when foam snack were consumed immediately after the main meals.

The effects of foam consumption on diet plan satisfaction are shown in Table 4.

TABLE 4
The effects of the foam products on diet plan satisfaction
(LSmeans, in mm, n = 134) as shown by different questions
when the foam was provided during a diet plan either immediately
after the main meals, immediately after the snacks, between the
snacks and main meals, or not at all (control).

| | | | In- | |
|---|---|---|---|---|
| | | Meals + | between | Snacks + |
| | Control | foam | foam | foam |
| | Estimate | Estimate | Estimate | Estimate |
| How hungry have you | 54 | 37* | 41 | 47 |
| felt today? | | | | |
| How full have you felt | 45 | 56 | 58 | 59* |
| today? | | | | |
| How strong was your | 50 | 35* | 41 | 42 |
| desire to eat another | | | | |
| meal today? | | | | |
| How strong was your | 60 | 38* | 45 | 36* |
| desire to eat another | | | | |
| snack today? | | | | |
| How strong was your | 55 | 33* | 38 | 36* |
| desire to eat additional | | | | |
| foods today? | | | | |

*P < 0.05 versus control

Also when rated at the end of the day, three servings of 200 ml foam appeared efficacious during one day of a reduced-energy diet plan, as it reduced hunger feelings throughout the day. Again, this was particularly evident when foam was consumed immediately after the main meal. Also the reduction in the desire to eat another meal that day, the desire to eat another snack that day and the desire to eat additional foods that day was particularly evident when foam was consumed immediately after the main meal.

### Discussion

This study clearly established that 200 ml servings of this foam product are very efficacious for reducing hunger when consumed three times during one day of a reduced-energy diet plan. Surprisingly, these effects were particularly evident when foams were consumed immediately after the main meals. Effects were smaller and less consistent among the 6 lines scales used when the foam snacks were consumed immediately after the snack or when consumed in between snacks and the main meals. Also when rated at the end of the day using somewhat different types of questions, 200 ml foam snacks showed similar patterns of effects on retrospective ratings of eating motivations during the day, again showing the strongest effects when foams were consumed immediately after the main meals.

### REFERENCES

Fedoroff I, Polivy J, Herman C P. The specificity of restrained versus unrestrained eaters' responses to food cues: general desire to eat, or craving for the cued food? Appetite 2003; 41(1):7-13.
Flint A, Raben A, Blundell J E, Astrup A. Reproducibility, power and validity of visual analogue scares in assessment of appetite sensations in single test meal studies. International Journal Of Obesity 2000; 24:38-48.
Morgan J F, Reid F, Lacey J H. The SCOFF questionnaire: assessment of a new screening tool for eating disorders. Br Med J 1999; 319:1467-1468.
Polivy J, Herman C P, Warsh S. Internal and external components of emotionality in restrained and unrestrained eaters. J Abnormal Psychol 1978; 87(5):497-504.
Stratton R J, Stubbs R J, Hughes D, King N, Blundell J E, Elia M. Comparison of the traditional paper visual analogue scale questionnaire with an Apple Newton electronic appetite rating system (EARS) in free living subjects feeding ad libitum. European Journal Of Clinical Nutrition 1998; 52:737-41.
Stubbs R J, Hughes D A, Johnstone A M et al. The use of visual analogue scales to assess motivation to eat in human subjects: a review of their reliability and validity with an evaluation of new hand-held computerized systems for temporal tracking of appetite ratings. British Journal of Nutrition 2000; 84:405-15.

### BRIEF DESCRIPTION OF FIGURES

FIG. 1a. The effect of repeated consumption of 200 ml foam on hunger (LSmeans in MM) when the foam was provided during a diet plan either immediately after the main meals (n=36), immediately after the snacks (n=32), between the snacks and main meals (n=32) or not at all (control, n=34). *F=foam snack given;**foods given during standard diet plan

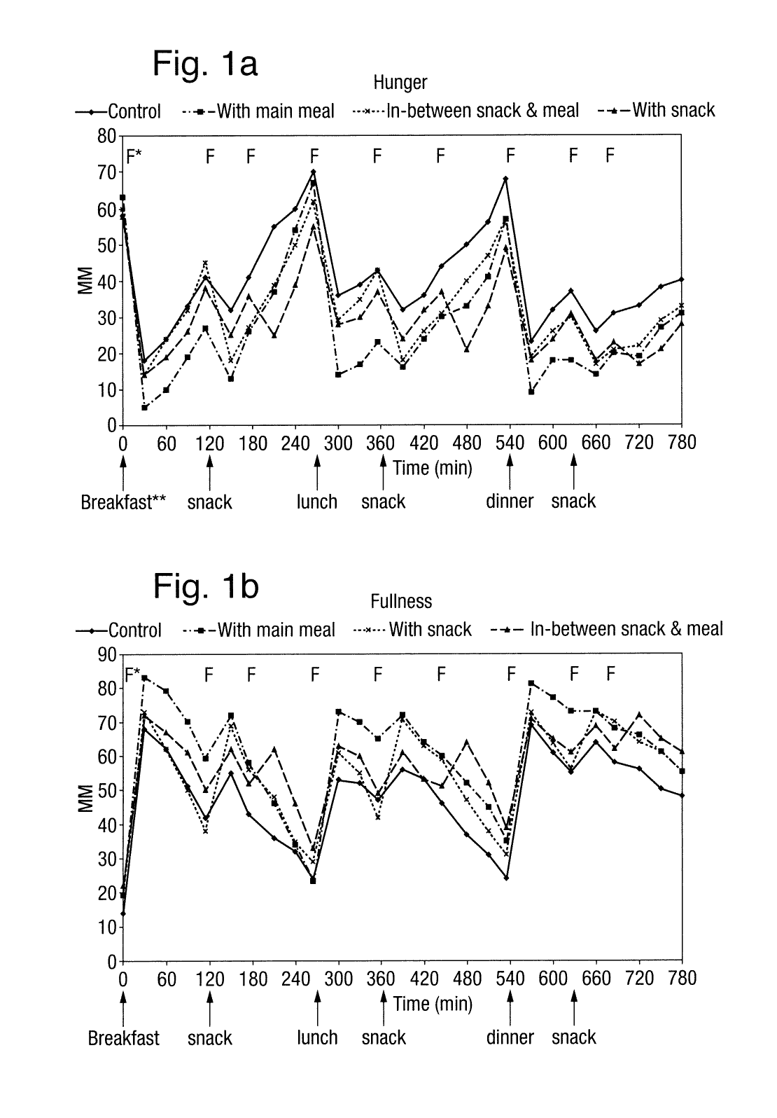

FIG. 1b. The effect of repeated consumption of 200 ml foam snacks on fullness (LSmeans in MM) when the foam was provided during a diet plan either immediately after the main meals, immediately after the snacks, between the snacks and main meals or not at all (control).

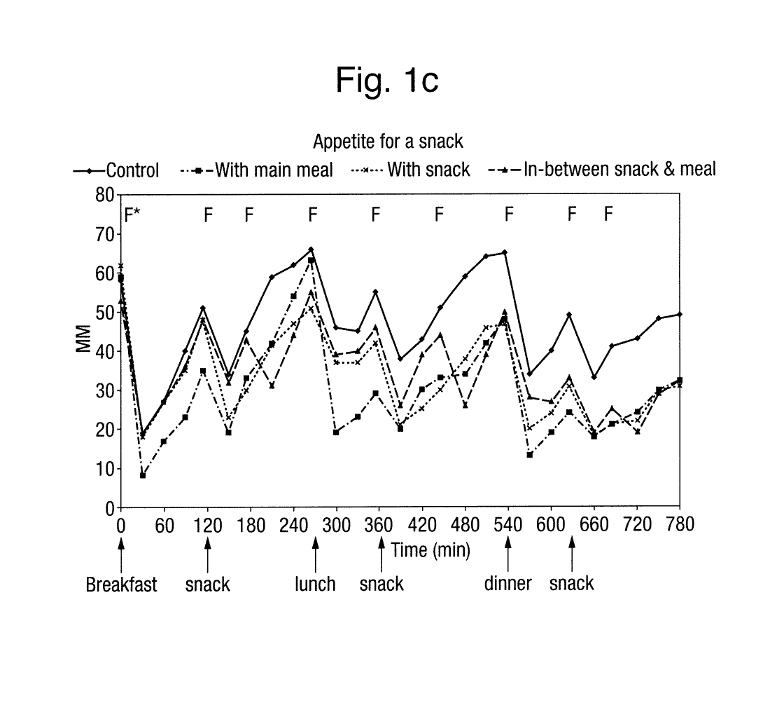

FIG. 1c. The effect of repeated consumption of 200 ml foam snacks on appetite for a snack (LSmeans in MM) when the foam was provided during a diet plan either immediately after the main meals, immediately after the snacks, between the snacks and main meals or not at all (control).

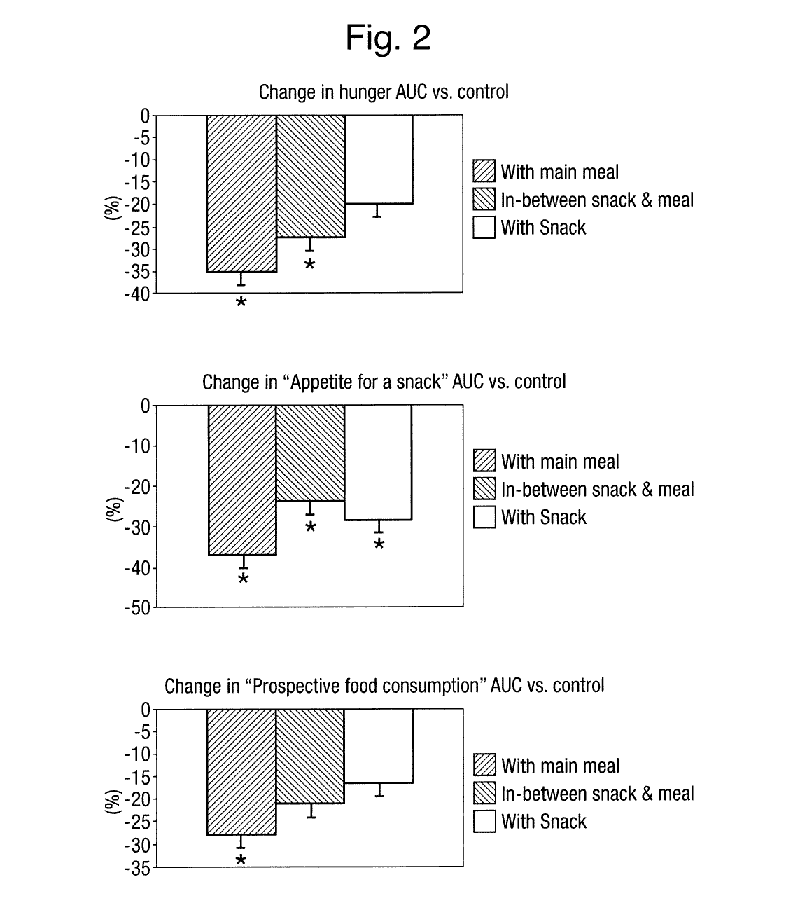

FIG. 2. Relative difference in VAS scores versus control (in %) for total area-under-the-curve (AUC for 0-780 min) * P<0.05 (columns from left to-right: immediately after the main meal; in-between snack and meal; immediately after the snack; relative difference (in %) is defined as 100%*(AUC treatment−AUC control)/AUC control)

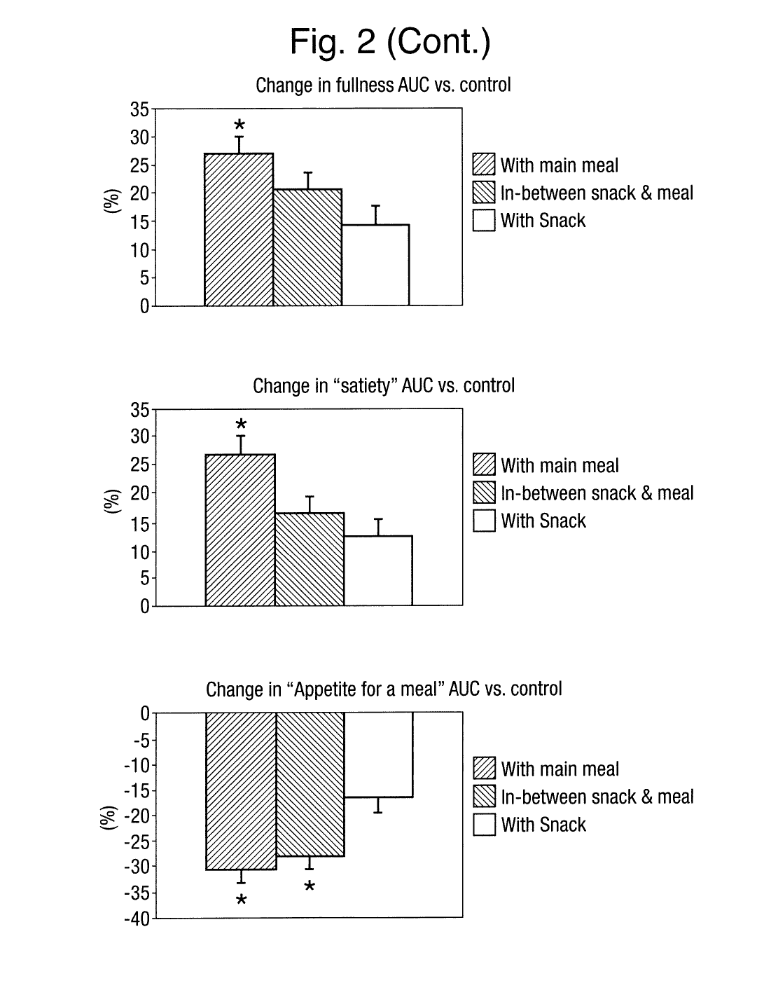

1. Method for reduction of food or energy intake in an individual, which method comprises:
ingesting by the individual or prescribed to the individual a diet reduced in calories,
said diet comprising at least two eating occasions on a day, wherein such eating occasion is the ingestion of an amount of food of at least 150 g and providing at least 200 kilo calories,
which method further comprises ingestion by said individual on at least two different of such eating occasions on a day or within 60 minutes prior to or after such eating occasion a portion of a pourable or spoonable aerated composition,
wherein each portion of aerated composition is an edible composition having a volume of 50 to 400 ml, an overrun of more than 100%, and a caloric density of less than 3 kcal/ml, and
wherein the total amount of all portions of aerated composition ingested per day is from 300 to 800 ml.

2. (canceled)

3. Method according to claim 1, wherein the method comprises ingestion by said individual on at least two different of such eating occasions on a day or within 30 minutes prior to or after such eating occasion a portion of an aerated composition.

4. Method according to claim 1, wherein the eating occasions are meals selected from breakfast, lunch or dinner.

5. Method according to claim 1, wherein the method comprises ingestion of said portion of an aerated composition as part of or an adjunct to an eating occasion.

6. Method according to claim 1 wherein the aerated composition comprises by weight 50-99.5% water, a foaming agent and a stabiliser.

7. Method according to claim 6, wherein foaming agent comprises one or more of:
a water-soluble emulsifier having an HLB value of at least 8, preferably at least 9, more preferably at least 12;
a food grade protein;
food grade amphiphatic particles having a contact angle at air/water interface between 70 and 120 degrees, and preferably having a volume weighted mean diameter of 0.02 to 10 micron (μm).

8. Method according to claim 1 wherein the aerated composition has a foam stability such that said aerated composition has a bench-life stability of at least 1 hour, wherein bench-life is determined by the methodology defined in the description.

9. Method according to claim 1, wherein the aerated composition has a caloric density of less than 2 kcal/ml, preferably less than 1 kcal/ml, more preferably less than 0.5 kcal/ml.

10. Method according to claim 1, wherein the aerated composition to be consumed is dispensed from a pressurized container containing a dispensing nozzle, and which container holds a liquid and a pressurized gas.

11. Method according to claim 1, wherein the method is used for individuals for compliance to a diet plan and/or for weight reduction and/or for weight maintenance after having followed a weight reduction diet and/or for a controlled energy intake of an individual after said individual leas followed a weight reduction diet.

12. (canceled)

13. An edible pourable or spoonable aerated composition having a volume of 50 to 400 ml, an overrun of more than 100%, and a caloric density of less than 3 kcal/ml for reduction of food or energy intake in an individual, wherein said individual is on a diet reduced in calories, wherein said diet comprises at least two eating occasions on a day, wherein such eating occasion is the ingestion of an amount of food of at least 150 g and providing at least 200 kilo calories, for use in the treatment of reduction of food or energy intake in an individual, said treatment comprising ingestion by said individual said edible aerated composition on at least two different of such eating occasions on a day or within 60 minutes prior to or after such eating occasion a portion of said aerated composition, and wherein the total amount of all portions of aerated composition ingested per day is from 300 to 800 ml.

14. (canceled)
